(19) United States
(12) Patent Application Publication
(10) Pub. No.: US 2006/0008109 A1
(43) Pub. Date: Jan. 12, 2006

(54) Loudspeaker structure

(76) Inventors: Maurice R.C. Huang, Taichung City (TW); Lee Cheng Ta, Taichung City (TW)

Correspondence Address: CHARLES E. BAXLEY, ESQ., 90 JOHN STREET, THIRD FLOOR, NEW YORK, NY, 10038, US

(21) Appl. No.: 11/219,389

(22) Filed: Sep. 6, 2005

Related U.S. Application Data
(63) Continuation-in-part of application No. 10/887,256, filed on Jul. 7, 2004.

(51) Int. Cl. H04R 25/00

(52) U.S. Cl. 381/396

(57) ABSTRACT

The present invention relates to a loudspeaker structure in accordance with one aspect of the present invention comprises a bowl-shaped frame, a central column is integrally formed in the frame and faces an opening end of the frame, the central column axially formed with a threaded hole, and a fixing element passing through the threaded hole for fixing a front piece, a magnet and a yoke iron on top surface of the central column.

This is a continuation-in-part of application Ser. No. 10/887,256 filed Jul. 07, 2004 entitled loudspeaker structure.

### BACKGROUND OF THE INVENTION

1. Field of the Invention

This invention relates to a loudspeaker structure, and more particularly to a loudspeaker capable of improving acoustic effect and reducing thickness without changing the output power and the anti-magnet effect.

2. Description of the Prior Arts

As shown in FIG. 1, a conventional inner-magnet loudspeaker structure includes a frame 11 that is interiorly provided from inside outward with a voice coil 12, an elastic wave 13, a nylon thread 14 and a cone paper 15. A dust-proof cover 16 is provided at the center inside of the cone paper 15, and a terminal 17 is arranged on the outer periphery of the frame 11 for exterior electrical connection. On an outer end of the frame 11 is sequentially provided a front piece 18, a magnet 19 and a yoke iron 21. And a conventional outer-magnet loudspeaker structure is shown in FIG. 2 and the difference is that on an outer end of the frame 11 is sequentially provided a front piece 22, a first magnet 23, a rear piece 24, a second magnet 25 and an anti-magnet cover 26. However, both the inner-magnet and the outer-magnet loudspeaker still have some defects that are to be explained as follows:

First, the inner-magnet and the outer-magnet loudspeaker use the cone paper 15 as vibration device, and the front pieces 18, 22, the magnets 19, 23, 25 and the other components are assembled on and protrude out of the outer end of the frame 11. In this case, the thickness of the loudspeaker is increased, so that the loudspeaker is inapplicable to products of small size, such as TFT (thin film transistor) type flat LCD (liquid crystal display), LCD flat type TV and Plasma Display Panel Television (PDPT), or the auto or household acoustics. These TV products are light and thin. If the conventional inner-magnet or the outer-magnet loudspeaker are assembled inside or outside these light and thin TV products by force, it will occupy a lot of space, so that there is no surplus space structure can be spared to resonate with the speaker, which will lead to decrease in output power and acoustic quality of the TV products.

Second, the frame 11 is normally made of iron material, and at the bottom center of the frame is formed a through hole 111 for reception of the front piece 18, 22, the voice coil 12 and others components. The through hole 111 will be diverged from the bottom center of the frame 11 in case that a mistake is caused when assembling the frame 11. Thus, the acoustic effect will not be good.

Third, the voice of the loudspeaker is produced by vibration of the cone paper 15, and the cone paper 15 is cone-shaped and which is not interiorly provided with spacer structure. Thus, sound waves produced by the cone paper 15 will interfere with one another during transmission, so that acoustic effect of the loudspeaker will not be good.

Fourth, with reference to FIG. 3, a sound box 27 is equipped with two inner-magnet loudspeakers, and there is no spacer between the cone papers 15, so that sound source point of the high-pitched wave and that of the base-tone wave are not clear. Furthermore, since the loudspeaker occupies a lot of space, the corresponding sound box 27 used to cooperate with the loudspeaker should be large enough in order to provide optimum acoustic quality.

Another loudspeaker is disclosed by White (US2002/0106101A1) and comprises a dished rear suspension carrier in which are arranged a hub and a screw. However, the dished rear suspension carrier, the hub and the screw are only used as a fixing mechanism for fixing the respective components of the loudspeaker. And is this loudspeaker has the same disadvantages as that of the aforementioned conventional loudspeaker.

Another loudspeaker as disclosed by Shelley (U.S. Pat. No. 6,771,791) is defined on the frame with a plurality of vents, and these vents operates as both an intake for cooling air which is drawn across the voice coil during positive excursion.

The present invention has arisen to mitigate and/or obviate the afore-described disadvantages of the conventional loudspeaker structure.

### SUMMARY OF THE INVENTION

The primary object of the present invention is to provide a loudspeaker structure capable of reducing the thickness without changing the output power and the anti-magnet effect.

The second object of the present invention is to provide a loudspeaker structure capable of decreasing the defective ratio during the assembly process of the loudspeaker.

Another object of the present invention is to provide a loudspeaker structure having better acoustic quality.

Yet another object of the present invention is to provide a loudspeaker structure wherein the sound source point of the loudspeaker is quite clear.

A loudspeaker structure in accordance with one aspect of the present invention comprises a bowl-shaped frame, a central column is integrally formed in the frame and faces an opening end of the frame, the central column axially formed with a threaded hole, and a fixing element passing through the threaded hole for fixing a front piece, a magnet and a yoke iron on top surface of the central column. The central column is dimensioned according to needs so that it can serve as a spacer for preventing sound waves produced by the loudspeaker structure interfering with one another during transmission, and thus a reflection effect of the sound waves is clear, and accordingly acoustic effect of the loudspeaker is improved.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is an assembly cross sectional view of a conventional inner-magnet loudspeaker;

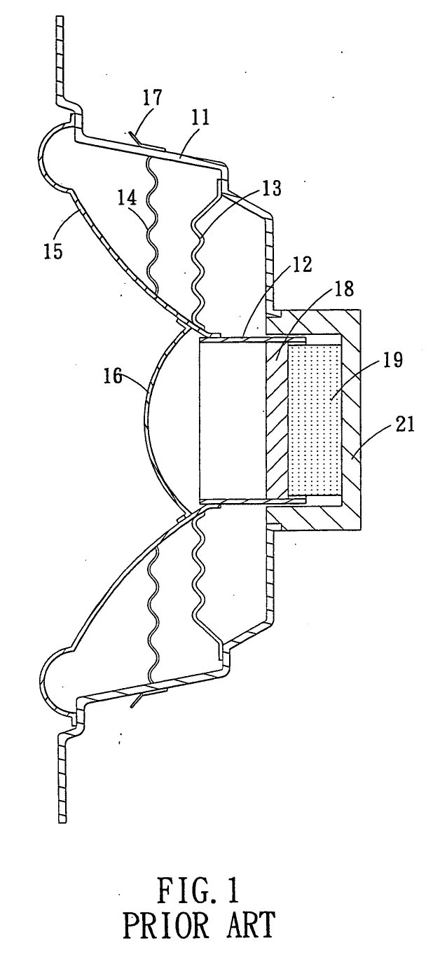

FIG. 2 is an assembly cross sectional view of a conventional outer-magnet loudspeaker;

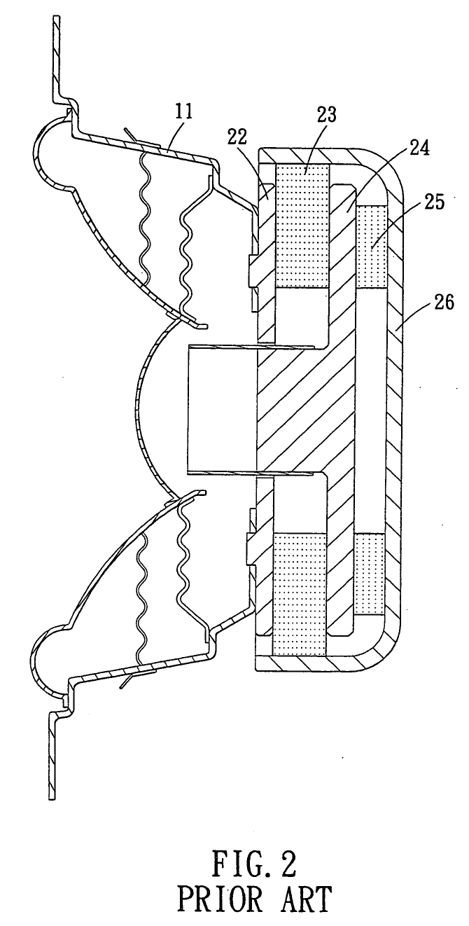

FIG. 3 shows a conventional inner-magnet loudspeaker is assembled in a sound box;

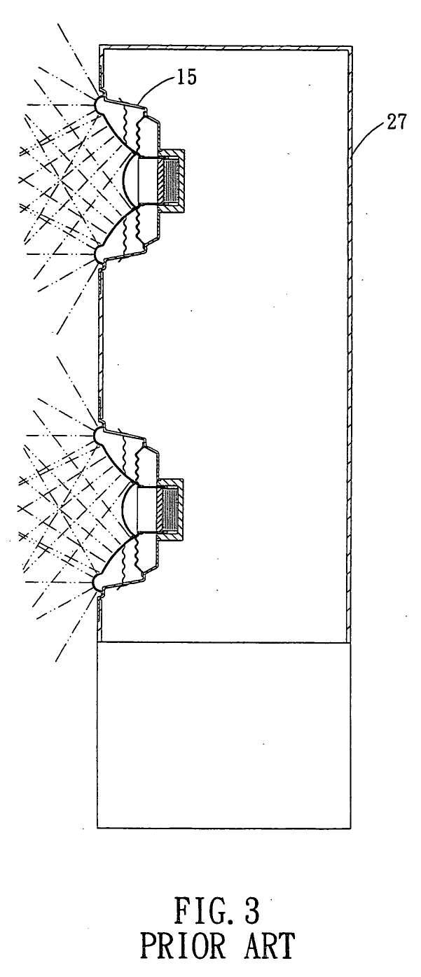

FIG. 4 is an assembly cross sectional view of a loudspeaker in accordance with the present invention;

FIG. 5 shows the loudspeaker in accordance with the present invention is emitting sound waves;

FIG. 6 shows the loudspeaker assembled in a sound box in accordance with the present invention is emitting sound waves;

FIG. 7 is a cross sectional view of showing a loudspeaker in accordance with the present invention wherein the central column is provided with ventilation holes;

FIG. 8 is an assembly cross sectional view of a loudspeaker in accordance with another embodiment of the present invention.

### DETAILED DESCRIPTION OF THE PREFERRED EMBODIMENT

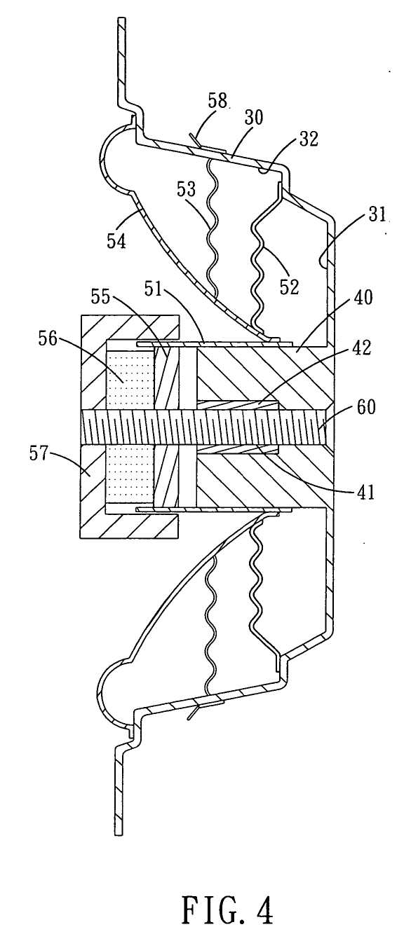

Referring to FIG. 4, a loudspeaker structure in accordance with an embodiment of the present invention is shown and generally includes a bowl-shaped frame 30. A central column 40 is integrally formed at the center of a bottom surface 31 inside the frame 30 and faces opening end of the frame 30. The central column 40 is axially formed with a threaded hole 41, in which, is screwed with a screw nut 42. A voice coil 51 is provided on the outer periphery of the central column 40. The diameter and height of the central column 40 are sized accordingly to the size of the paper so that the sound wave (indicated by the dotted line) produced by the cone paper 54 (including the yoke iron 57) will be reflected by the central column. Thus the reflection effect of the sound wave is clear, and accordingly the acoustic effect is improved.

On the inner periphery 32 of the frame 30 are provided from inside outward with an elastic wave 52, a nickel fiber 53 and a cone paper 54, respectively. The cone paper 54 is adhered to the periphery of the voice coil 51, and a fixing element 60 is screwed with the screw nut 42 after passing through the threaded hole 41. A front piece 55, a magnet 56 and a yoke iron 57 are sequentially arranged on the top end of the central column 40. On the outer periphery of the frame 30 is further provided with terminals 58 for exterior electrical connection.

Since the central column 40 is formed in the opening end of the frame 30, and the front piece 55, the magnet 56 and the yoke iron 57 are arranged on the top end of the central column 40, the thickness of the loudspeaker can be substantially reduced. Thus, the loudspeaker, under the condition that the output power is not reduced, is applicable to products having small structural space, such as TFT type flat LCD, LCD flat type TV, PDPT, or the auto or household acoustics.

Besides, the loudspeaker in accordance with the present invention further has the advantages as follows:

First, the frame 30 replaces the conventional frame, and the central column 40 is integrally formed in the opening end of the frame 30. Such structural design allows the central column 40 to be accurately formed on the center of the bottom surface of the frame 30, and to further allow the rest components of the loudspeaker to be arranged accurately on the top surface of the central column 40 without any alignment operation. Thereby, the defective fraction caused in assembly of the loudspeaker is reduced, and the cost is accordingly decreased.

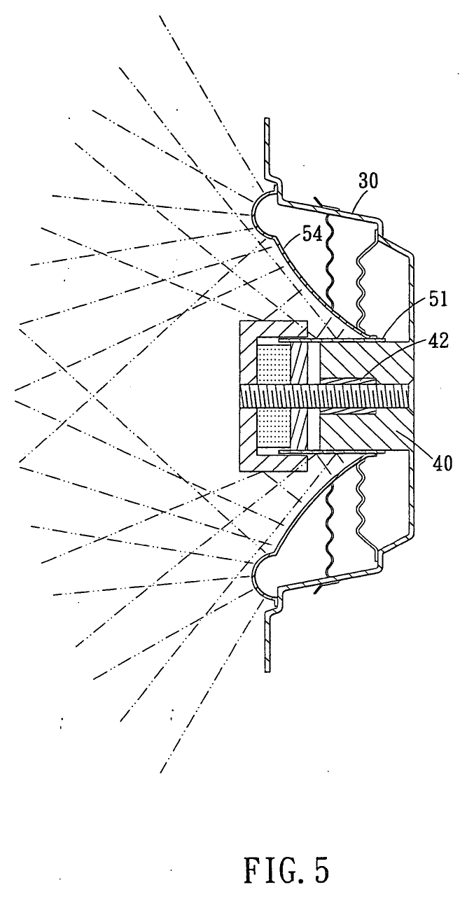

Second, as shown in FIG. 5, the central column 40 is formed at the bottom center of the frame 30, and on the outer periphery of the central column 40 are provided with the elastic wave 52 and the voice coil 51. The cone paper 54 is located between the voice coil 51 and the frame 30. In this case, the central column 40 is located in the center of the cone paper 54 and acts as a spacer, such that, when the loudspeaker is in use, the central column 40 will reflect the sound wave (indicated by the dotted line) produced by the cone paper 54 (including the yoke iron 57). Thus the reflection effect of the sound wave is clear, and accordingly the acoustic effect is improved.

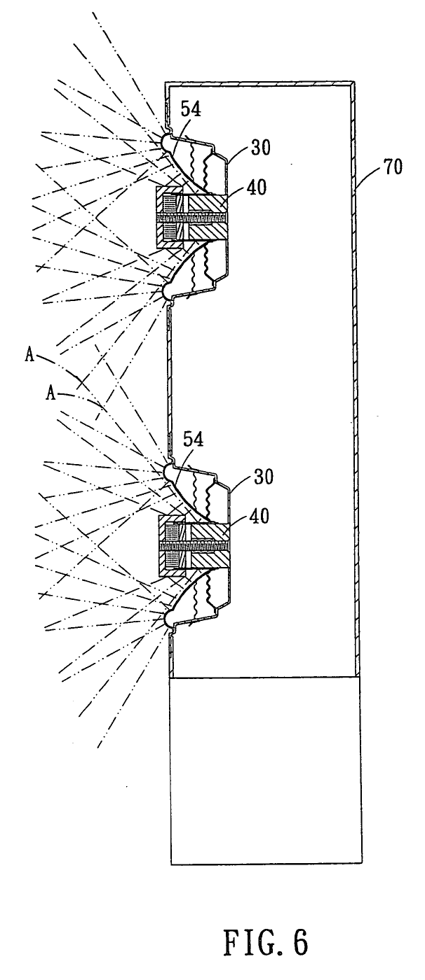

Third, as shown in FIG. 6, the loudspeaker in accordance with the present invention can be set in the sound box 70 of the acoustic equipments. Furthermore, the central column 40 is formed in the opening end of the frame 30 and located in the cone paper 54 in a protruding manner. In this case, the trace of the sound wave produced by the cone paper 54 and reflected by the central column 40 is quite regular, such that the direction of the sound wave between the loudspeakers is clear, and sound source points A are also clear. Thereby, the acoustic effect will be improved. Furthermore, the thickness of the loudspeaker is reduced without influencing the output power, and the corresponding sound box can be accordingly smaller as compared to the conventional one.

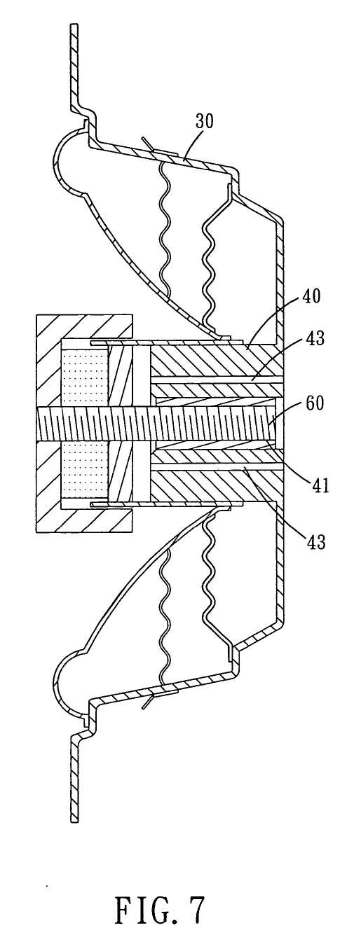

It will noted that, as shown in FIG. 7, plural ventilation holes 43 are coaxially and symmetrically formed around the threaded hole 41 of the central column 40, and the quantity of the ventilation holes 43 can be 2, 4 or 6. Besides the above-mentioned advantages, when the loudspeaker is in use after being assembled in the sound box of acoustic equipments, since the central column 40 is axially formed with plural ventilation holes 43 allowing flow of air, the ventilation holes 43 can balance the air pressure caused by vibration of the loudspeaker, so that the acoustic effect can be improved.

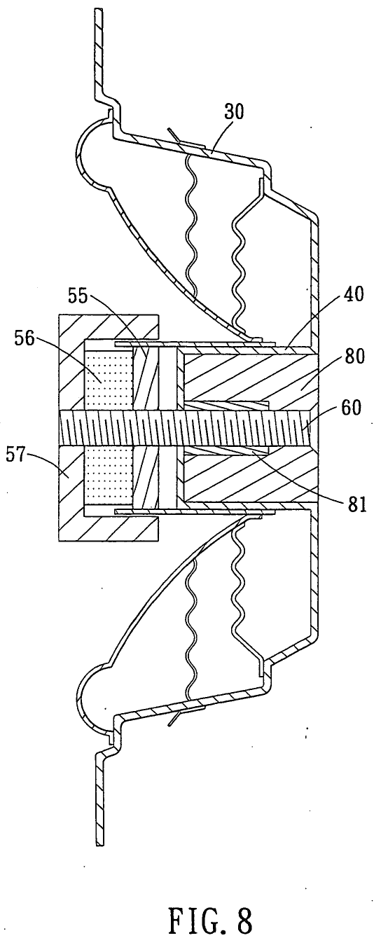

Referring to FIG. 8, a frame of loudspeaker in accordance with another embodiment of the present invention is shown. In which, the central column 40 of the frame 30 is hollow and interiorly provided with a chock 80 which is interiorly received with a screw nut 81 for screwing with the fixing element 60. And thus the front piece 55, the magnet 56 and the yoke iron 57 are allowed to be assembled on the top surface of the central column 40. The loudspeaker in this embodiment has the same functions as the loudspeaker of the first embodiment does, so further explanations will be omitted.

While we have shown and described various embodiments in accordance with the present invention, it should be clear to those skilled in the art that further embodiments may be made without departing from the scope of the present invention.

What is claimed is:

1. A loudspeaker structure comprising a bowl-shaped frame, a central column integrally formed in the frame and facing an opening end of the frame, the central column axially formed with a threaded hole, and a fixing element passing through the threaded hole for fixing front piece, magnet and yoke iron on top surface of the central column;
wherein the central column is dimensioned according to needs so that it can serve as a spacer for preventing sound waves produced by the loudspeaker structure interfering with one another during transmission, and thus a reflection effect of the sound waves is clear, and accordingly acoustic effect of the loudspeaker is improved.

2. The loudspeaker structure as claimed in claim 1, wherein a screw nut is received in the threaded hole of the central column, and the fixing element is screwed in the threaded hole.

3. The loudspeaker structure as claimed in claim 1, wherein plural ventilation holes are coaxially formed about the threaded hole of the central hole.

4. The loudspeaker structure as claimed in claim 1, wherein the central column is hollow and interiorly provided with a chock that is provided for insertion of the fixing element, so that the front piece, the magnet and the yoke iron are allowed to be assembled on the top surface of the central column.

5. The loudspeaker structure as claimed in claim 1, wherein a screw nut is disposed in the chock for meshing with the fixing element.
